(19) United States
(12) Patent Application Publication
(10) Pub. No.: US 2002/0089620 A1
(43) Pub. Date: Jul. 11, 2002

(54) Anisotropic scattering film and liquid crystal display

(76) Inventors: Kyoko Yamamoto, Tsukuba-shi (JP); Masato Kuwabara, Tsukuba-shi (JP); Yasuteru Maeda, Kitasoma-gun (JP); Koichi Fujisawa, Tsukuba-shi (JP)

Correspondence Address: BIRCH STEWART KOLASCH & BIRCH, PO BOX 747, FALLS CHURCH, VA, 22040-0747, US

(21) Appl. No.: 09/907,903

(22) Filed: Jul. 19, 2001

(30) Foreign Application Priority Data
Jul. 21, 2000 (JP) 2000-220514
Sep. 19, 2000 (JP) 2000-283114

(51) Int. Cl. G02F 1/1335; C09K 19/00

(52) U.S. Cl. 349/96; 428/1.31

(57) ABSTRACT

Provided is an anisotropic scattering film comprising a micro-porous film and a substance in micro pores of said micro-porous film, wherein the micro pores observed on the surface of the film are substantially in the form of ellipse, the ratio of the major axis to the minor axis (major axis/minor axis) of said ellipse is over 1, the minor axis size of the micro pores is smaller than the wavelength of light, the directions of micro pores along the major axis are oriented to substantially one direction, the refractive index of the substance in micro pores of the micro-porous film differs from the refractive index of the micro-porous film, and the anisotropic scattering film has scattering anisotropy to a polarizing component of a polarized light.

The anisotropic scattering film has high transmittance and excellent scattering property, and a liquid crystal display having high luminance can be obtained by using the anisotropic scattering film.

### BACKGROUND OF THE INVENTION

1. Field of the Invention

The present invention relates to an anisotropic scattering film and a liquid crystal display using the anisotropic scattering film.

2. Description of the Related Art

In conventional liquid crystal panels, brightness thereof has been reduced to half or less of the original brightness of a back light since an absorption type polarizing plate is used. In use, due to two polarizing plates on the front side and back side of a liquid crystal panel, light utilization efficiency becomes lower, and the brightness thereof is reduced to 30% to 40% of the original brightness of a back light. Therefore, there are trials of converting polarization to compensate these defects, for enhancing light utilization efficiency.

For example, JP-A No.11-509014 discloses a polarized element wherein anisotropic particles having a specific size are arranged in an isotropic material at a specific interval. However, the polarized element has problems that satisfactory scattering strength is not obtained, and controlling the dispersibility of particles is difficult.

JP-A9-297204 discloses an anisotropic scattering element where scattering particles whose aspect ratio is 1 or more, are dispersed with arranging to one direction, in a supporting medium having a refractive index different from the scattering particles. However, the anisotropic scattering element has also problems that satisfactory scattering strength is not obtained, and controlling the dispersibility of anisotropic scattering particles is difficult.

### SUMMARY OF THE INVENTION

An object of the present invention is to provide an anisotropic scattering film which has high transmittance and excellent scattering property, and a liquid crystal display having high luminance obtained by using the above-mentioned anisotropic scattering film.

The present inventors have intensively studied for solving the above-mentioned problems, and resultantly found that an anisotropic scattering film comprising a micro-porous film and a substance having a refractive index different from the refractive index of the micro-porous film in micro pores of said micro-porous film, has a high transmittance and excellent scattering property and that luminance of a liquid crystal display can be enhanced using this film, leading to completion of the present invention. The anisotropic scattering film of the present invention can be produced easily as well.

First, the present invention relates to an anisotropic scattering film comprising a micro-porous film and a substance in micro pores of said micro-porous film, wherein the micro pores observed on the surface of the film are substantially in the form of ellipse, the ratio of the major axis to the minor axis (major axis/minor axis) of said ellipse is over 1, the minor axis size of the micro pores is smaller than the wavelength of light, the directions of micro pores along the major axis are oriented to substantially one direction, the refractive index of the substance in micro pores of the micro-porous film differs from the refractive index of the micro-porous film, and the anisotropic scattering film has scattering anisotropy to a polarizing component of a polarized light.

Second, the present invention relates to a liquid crystal display comprising a liquid crystal panel having a polarizing plate at least on the front surface side, the anisotropic scattering film described above, a light guide, and a reflection plate or a diffuse reflection plate piled in this order, wherein the transmission axis of said liquid crystal panel and the transmission axis of said anisotropic scattering film are approximately parallel.

### BRIEF DESCRIPTION OF THE DRAWINGS

FIG. 1 is a view showing the surface of a micro-porous film.

FIG. 2 is a view showing the form and the major axis and minor axis directions of a micro pore.

FIG. 3 is a view showing constitution of a liquid crystal display.

FIG. 4 is a view showing constitution of a liquid crystal display.

FIG. 5 is a view showing mechanism of a liquid crystal display.

The denotations used in the figures are as follows.

1: Anisotropic scattering film

2: Micro pore in film surface

3: Minor axis size in film surface of micro pore

4: Major axis size in film surface of micro pore

5: Orientation of major axis

6: Polarizing plate

7: Liquid crystal cell

8: Back light

9: Reflection plate or diffuse reflection plate

10: Retardation plate

11: Polarized light having a plane of vibration vertical to paper surface

12: polarized light having a plane of vibration parallel to paper surface

### DETAILED DESCRIPTION OF THE INVENTION

The anisotropic scattering film referred to in the present invention is a film having scattering anisotropy to a polarizing component of the polarized light.

The micro-porous film means a porous or sponge-like film. Namely, in the film, the micro pores may be substantially connected mutually, or not connected mutually. The micro-porous film can be a film having so-called “penetrating pores” in which micro pores are substantially connected mutually through curved paths from the surface to the other surface of the film. The micro pores in the present invention include penetrating pores.

Gas permeability is an index showing the penetrating pores in the micro-porous film, and suitably 5 to 5,000 sec/100 cc·cm². When the gas permeability is over 5,000 sec/100 cc·cm², filling procedure of the substance may become difficult. When it is below 5 sec/100 cc·cm², desired optical characteristics are often not exhibited. Gas permeability is measured according to JIS P-8117.

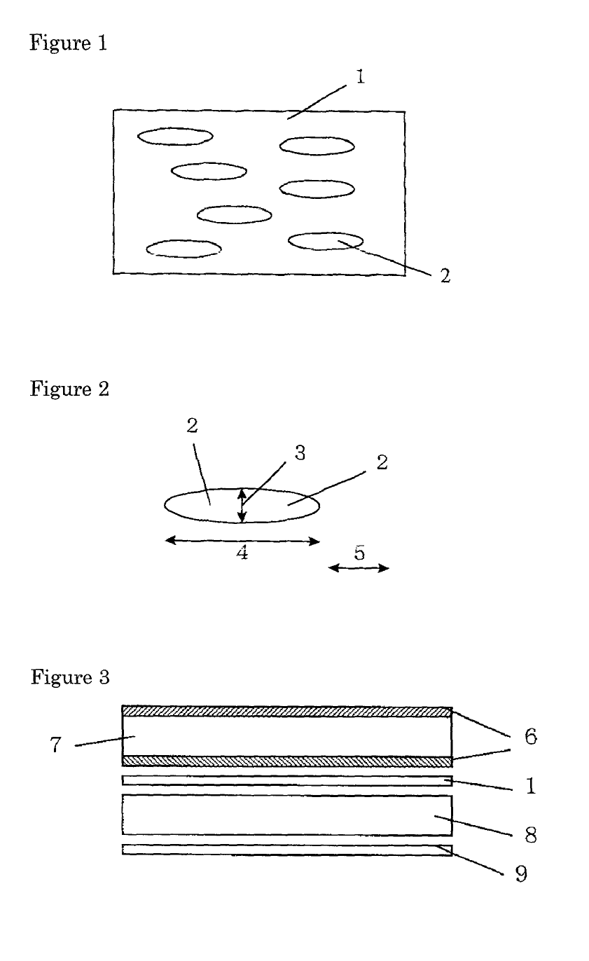

As shown in FIG. 1, micro pores observed on the surface or inside of a film are substantially in ellipse form. The ellipse form includes ellipse forms such as an oval form, double convex lens form and the like in a broad sense, and it is not restricted as long as the form has a major axis and a minor axis, differing from circular form.

The ratio of the major axis to the minor axis of the ellipse [(major axis/minor axis), hereinafter, this ratio is referred to as aspect ratio] is over 1, suitably from 1.01 to 50, more suitably from 3 to 30, and further suitably from 4 to 30.

The directions along the major axis of the micro pores on the surface of the film are oriented to substantially one direction.

The minor axis size of the ellipse is required to be less than the wavelength of light. It is suitably 50% or less of the wavelength of light.

The major axis size of the ellipse is required to be equal to or more than the wavelength of light. It is suitably more than twice of the wavelength of light.

The wavelength of light depends on the conditions in which the anisotropic scattering film of the present invention is used. As for a liquid crystal display, it usually means a wavelength in a visible light region (wavelength of 400 to 800 nm).

The void fraction occupied by micro pores in the above-mentioned micro-porous film is not particularly restricted, and preferably from 30 to 85%, further preferably from 50 to 75%. When the void fraction is less than 30%, sufficient transmittance is not obtained, and when over 85%, mechanical strength decreases.

The material used in the anisotropic scattering film is desirably a polymer from the standpoints of weight-lightening, and molding. The polymer is preferably a polymer which causes no change in optical properties and forms, when the anisotropic scattering film is used at a higher temperature or when exposed to a temperature during lamination onto a liquid crystal cell.

Regarding the glass transition temperature or softening temperature of a polymer, the lower limit is so determined that change in optical properties and shrinkage of a film do not occur at temperatures within a range in which a liquid crystal display is used. The glass transition temperature or softening temperature of a polymer is suitably from 40 to 250° C., more suitably from 50 to 230° C., further suitably from 60 to 200° C.

As the polymer, polyolefin-based polymers and the like are exemplified. Examples of the polyolefin-based polymers include: α-olefin homopolymer of ethylene, propylene, butene, pentene, hexane and the like; a copolymer of ethylene-propylene, ethylene-butene, ethylene-pentene, ethylene-hexene and the like; and a blend thereof, without being limited.

Additives may be used for the purpose of improving mechanical strength of these polymers or improving adhesion of these polymers in lamination to an LCD cell. The kind and amount of additives are not particularly restricted providing they do not deteriorate the object of the present invention. Examples of the additives include, anti-oxidant, light stabilizer, heat-stabilizer, lubricant, dispersing agent, UV absorber, white pigment, fluorescent whitening agent, without being limited.

The film thickness of the above-mentioned micro-porous film is not particularly restricted, and preferably from 1 to 500 μm, further preferably from 20 to 200 μm. When the film thickness is less than 1 μm, sufficient scattering is not obtained, and when over 500 μm, light does not transmit sufficiently.

The micro-porous film may be a laminated film containing two or more of film.

As the method of producing a porous film, the following methods are exemplified.

(1) A method in which fillers are added to a resin, and a film is formed then drawn (JP-B No. 55-9131).

(2) A method in which micro particles are synthesized in a molten polymer, and a film is formed then drawn (JP-A No. 10-287758).

(3) A method in which fillers and plasticizers are added to a resin, and a film is formed then drawn (JP-B No. 7-15021).

(4) A method in which fillers which have been surface-treated are added to a resin, and a film is formed then drawn (JP-A No. 63-210144).

(5) A method in which fillers and a crystal nucleating agent are added to a resin, and a film is formed then drawn (JP-A No. 64-54042).

(6) A method in which an incompatible resin is added to a resin, and a film is formed then drawn (JP-A No. 4-142341).

(7) A method in which an extractable substance is added to a resin, and a film is formed and the extractable substance is extracted and drawn (JP-A No. 1-201342).

(8) A method in which a crystalline resin is molded into a film which is drawn by a solvent stretch method (JP-B No. 2-19141).

(9) A method in which a crystal nucleating agent are added to a crystalline resin, and a film is formed then drawn (JP-B No. 7-5780).

(10) A method using processes of cold drawing and hot drawing (JP-B No. 2-11620).

(11) A method in which a film obtained by a solvent cast method is dried and drawn (JP-A No. 5-98065).

A porous film can be produced by the above-mentioned various methods, and the micro-porous film used in the anisotropic scattering film of the present invention is required to be a film in which micro pores observed on the surface of the film is substantially in the form of ellipse, the ratio of the major axis to the minor axis (major axis/minor axis) of the ellipse is over 1, the minor axis size of the micro pore is smaller than the wavelength of light, directions of micro pores along the major axis are oriented to substantially one direction. The major axis size is preferably equal with the wavelength of light or longer.

The minor axis size of a micro pore can be controlled to a certain extent in producing a porous film. For example, when a porous film is obtained by molding a polymer resin, fine inorganic powder and plasticizer into a film while kneading and heat-melting them, then the resin is molded into a film, drawing the film along only a uni-axial direction or bi-axial direction, then, extracting off the fine inorganic powder and plasticizer and drying the film, the minor axis size can be controlled by changing the particle size of the fine inorganic micro powder used.

The ratio of the major axis to the minor axis (aspect ratio: major axis/minor axis) can be controlled by changing drawing ratio in drawing.

The drawing ratio is preferably in a range from 1.5 to 30-fold, further preferably in a range from 2 to 20-fold, in terms of area drawing ratio. The drawing may be performed along uni-axial direction or bi-axial direction, and in the case of bi-axial direction, it is desirable that the drawing ratios are different between the orthogonal two directions, to increase the aspect ratio of micro pores.

The above resultant micro-porous film may be drawn further (it may be referred to as “a secondary drawing”).

The drawing at the time of manufacturing a micro-porous film (it may be referred to as “a primary drawing”) is preferably biaxial drawing in view of providing a high tear strength.

Since the secondary drawing is conducted in order to enlarge the aspect ratio of the elliptical form, and to arrange the direction of the major axis, it is suitable that the drawing contains uniaxial drawing, and it is more suitable that the drawing is substantially uniaxial drawing.

From the viewpoint of controlling the form of the micro pores, the width of the film, and the productivity, drawing ratio is suitably 1.2 to 10-fold, more suitably 1.3 to 5-fold.

The aspect ratio of elliptical form obtained by secondary drawing is suitably 3 to 30, more suitably 4 to 30.

A substance in the micro pores of the above-mentioned micro-porous film has a refractive index differing from the refractive index of the above-mentioned micro-porous film. The substance is not particularly restricted, but suitably colorless.

It is preferable that the difference between the refractive index of the above-mentioned micro-porous film and the refractive index of the above-mentioned substance is within a range based on back scattering. The back scattering means a phenomenon in which incident light is scattered in a hemisphere space in which a plane vertical to incident light is utilized as the bottom surface situated opposite to the incident direction.

The substance filled in the micro pores may be an inorganic substance, an organic substance or a gas such as air providing it has a refractive index differing from that of the micro-porous film. The substance may be either anisotropic or isotropic.

Examples of isotropic organic substances include, without being limited, polymethyl methacrylate, polybenzyl methacrylate, polyphenyl methacrylate, polydiallyl phthalate, polystyrene, poly P-boromophenyl methacrylate, polypentachlorophenyl methacrylate, polychlorostyrene, poly -α-naphthyl methacrylate polyvinylnaphthalene, polyvinylcarbazole, polypentabromophenyl methacrylate, bisvinylthiophenyl sulfide, bisepoxypropylthiophenyl sulfide, bismethacryloylthiophenyl sulfide, perchlorooctylethyl methacrylate, perfluorooctylethyl acrylate, acetone, methyl butyrate, 1-pentanol, cynnamaldehyde, carbon disulfide, 1,1,2,2-tetrabromoethane, 1-bromonaphthalene, acetaldehyde, acetonitrile, isobutyl alcohol, ethanol, 1-chloronaphthalene, 1-butanol, 2-butanol, t-butyl alcohol, 1-propanol, ethyl 2-propanolacetate, diethyl ether, dimethoxymethane and the like. These may be used alone or in combination.

The isotropic organic substance is preferably a polymerizable substance without being especially limited as long as it is transparent, and may be either thermoplastic, thermosetting or photopolymerizable type.

Examples of the photopolymerizable substance include: acryl monomers such as 2-ethylhexylacrylate, 2-hydroxyethylacrylate, neopentylglycol diacrylate, hexanediol diacrylate, diethleneglycol diacrylate, tripropyleneglycol diacrylate, polyethyleneglycol diacrylate, trimethylolpropane triacrylate, and pentaerythritol triacrylate; and acryl oligomers such as polyester acrylate, epoxy acrylate, and polyurethane acrylate.

For accelerating the polymerization, a polymerization initiator may also be added, and examples thereof include: 2-hydroxy-2-methyl-1-phenylpropane-1-one (Darocure 1173, manufactured by Merck), 1-hydroxycyclohexylphenylketone (Irgacure 184, manufactured by Chiba Specialty Chemicals), 1-(4-isopropylphenyl)-2-hydroxy-2-methylpropane-1-on (Darocure 1116, manufactured by Merck), benzylmethylketal (Irgacure 651, manufactured by Chiba Specialty Chemicals), 2-methyl-1-[4-(methylthio)phenyl]-2-morpholinopropane-1-on (Irgacure 907, manufactured by Chiba Specialty Chemicals), acylphosphineoxide (LUCIRIN TPO, manufactured by BASF) and the like. Examples of a heat polymerization initiator include peroxides such as BPO, t-butyl peroxide and the like, radical generators such as azobisisobutyronitrile (AIBN) and the like, and amine compounds such as ethylamine, n-butylamine, benzylamine, diethylenetriamine, tetramethylenepentamine, menthenediamine, diaminodiphenylmethane and the like.

As the substance in the micro pores, an anisotropic substance is suitable, and a liquid crystal is more suitable.

Moreover, it is suitable that the following formulas are satisfied,

0.01<|n−ne|<0.6

0≦|n−no|<0.05

in the above formula, n is the refractive index of a micro-porous film, ne is the refractive index of the anisotropic substance to ordinary ray, and ne is the refractive index of the anisotropic substance to extraordinal ray. (ne>no).

The liquid crystal is not especially limited, but examples thereof include at least one compound selected from the group consisting of the following formulas (1), (2) and (3).

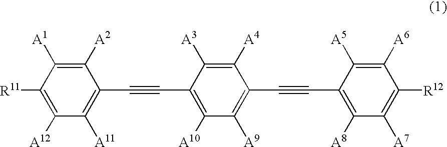

In the formula, A¹-A¹² represent, each independently, a hydrogen atom, a fluorine atom, an alkyl group or alkoxy group having 1-10 carbon atoms which may be substituted with fluorine. R¹¹ and R¹² represent, each independently, a hydrogen atom, a fluorine atom, a cyano group, SF₅, NCS (e.g. isothiocyanate group), 4-R¹³-(cycloalkyl) group, 4-R¹³-(cycloalkenyl group) or R¹⁴—(O)q¹¹. R¹³ represents a hydrogen atom, a linear or branched alkyl group having 1-12 carbon atoms which may be substituted with fluorine, and R¹⁴ represents a linear or branched alkyl group having 1-12 carbon atoms which may be substituted with fluorine. q¹¹ represents 0 or 1.

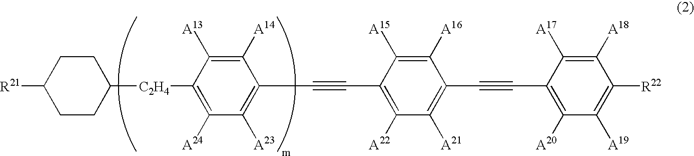

In the formula, A¹³-A²⁴ represent, each independently, a hydrogen atom, a fluorine atom, or an alkyl group having 1-10 carbon atoms. m is 0 or 1. R²¹ represents a hydrogen atom, a linear or branched alkyl group having 1-12 carbon atoms which may be substituted with fluorine. R²² represents R²¹, a fluorine atom, a cyano group, 4-R²³-(cycloalkyl) group, 4-R²³-(cycloalkenyl group) or R²⁴—(O)q²¹ . R²³ represents a hydrogen atom, a linear or branched alkyl group having 1-12 carbon atoms which may be substituted with fluorine, and R²⁴ represents a linear or branched alkyl group having 1-12 carbon atoms which may be substituted with fluorine. q²¹ represents 0 or 1.

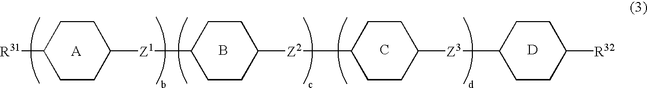

In the formula (3), ring A, ring B, ring C and ring D, each independently represents, 1,4-phenylene, 1,4-cyclohexylene, 1,4-cyclohexelene, 4,1-cyclohexelene, 2,5-cyclohexelene, 5,2-cyclohexelene, 3,6-cyclohexelene, 6,3-cyclohexelene, 2,5-pyrimidinediyl, 5,2-pyrimidinediyl, 2,5-pyridinediyl, 5,2-pyridinediyl, 2,5-dioxanediyl or 5,2-dioxanediyl. The hydrogen atom on ring A, ring B, ring C, and ring D may be substituted with a fluorine atom. R31 and R32 represent a hydrogen atom, a fluorine atom, fluoromethyl group, difluoromethyl group, trifluoromethyl group, fluoromethoxy group, difluoromethoxy group, trifluoromethoxy group, cyano group, an alkyl group having 1-12 carbon atoms, an alkenyl group having 3-12 carbon atoms, an alkynyl group having 3-12 carbon atoms, an alkoxy group having 1-12 carbon atoms, an alkenyloxy group having 3-12 carbon atoms, an alkynyloxy group having 3-12 carbon atoms, an alkoxyalkyl group having 2-16 carbon atoms, or an alkoxyalkenyl group having 3-16 carbon atoms. The methylene group in these alkyl group, alkenyl group, and alkynyl group, may be substituted with oxygen atom, sulfur atom, and silicon atom, and can be either linear or branched.

Z1, Z2, and Z3 represent, each independently, —COO—, —OCO—, —OCH₂—, —CH₂O—, an alkylene group having 1-5 carbon atoms, an alkenylene group having 2-5 carbon atoms, an alkynylene group having 2-5 carbon atoms, or a single bond. And b, c and d are 0 or 1 each independently, and satisfy b+c+d≧1.

Concrete examples of the compound represented by formula (1) are shown below.

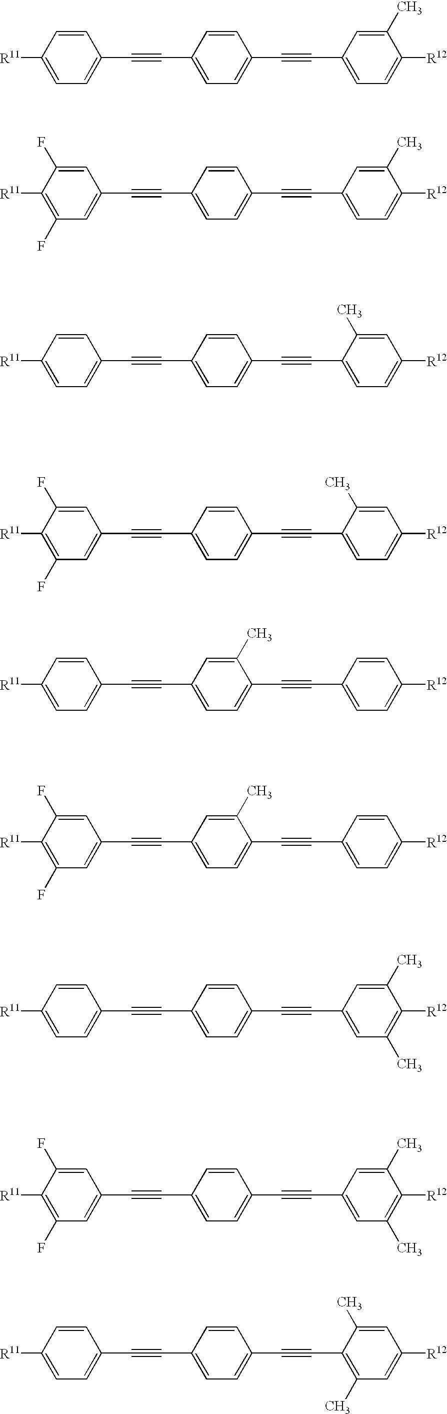

In the formula, concrete examples of R11 and R12 include: alkyl groups such as a hydrogen atom; fluorine atom; methyl group, ethyl group, propyl group, butyl group, pentyl group, hexyl group, heptyl group, octyl group, nonyl group, decyl group, undecyl group, and dodecyl group, and fluoroalkyl groups thereof substituted with fluorine atoms (for example, trifluoromethyl); alkoxy groups such as methoxy group, ethoxy group, propoxy group, butoxy group, pentyloxy group, hexyloxy group, octyloxy group, nonyloxy group, decyloxy group, undecyloxy group, dodecyloxy group, fluoroalkoxy groups thereof substituted with fluorine atoms (for example, methoxy group substituted with 1-3 fluorine atoms, and ethoxy group substituted with 1-5 fluorine atoms; alkoxyalkyl groups, such as methoxymethyl group, ethoxymethyl group, propoxymethyl group, butoxymethyl group, pentyloxymethyl group, hexyloxymethyl group, heptyloxymethyl group, octyloxymethyl group, nonyloxy methyl group, decyloxymethyl group, methoxyethyl group, ethoxy ethyl group, propoxyethyl group, butoxyethyl group, pentyloxy ethyl group, hexyloxyethyl group, heptyloxyethyl group, octyloxyethyl group, nonyloxyethyl group, decyloxyethyl group, methoxypropyl group, ethoxypropyl group, propoxypropyl group, butoxy propyl group, pentyloxypropyl group, hexyloxypropyl group, heptyloxypropyl group, octyloxypropyl group, nonyloxy propyl group, methoxybutyl group, ethoxybutyl group, propoxybutyl group, butoxybutyl group, pentyloxybutyl group, hexyloxybutyl group, heptyloxybutyl group, octyloxybutyl group, methoxypentyl group, ethoxypentyl group, propoxypentyl group, butoxypentyl group, pentyloxypentyl group, hexyloxypentyl group, heptyloxypentyl group, and fluoroalkoxyalkyl groups thereof substituted with fluorine atoms; branched alkyl groups, such as 2-methylpropyl group, 2-methyl butyl group, 3-methylbutyl group, and 3-methyl pentyl group, and branched fluoroalkyl groups thereof substituted with fluorine atoms; branched alkyloxy groups, such as 2-methylbutyloxy group, 3-methylbutyloxy group, and 3-methylpentyloxy group, and branched fluoroalkyloxy groups thereof substituted with fluorine atoms; 4-alkyl-cycloalkyl groups, such as 4-methylcyclohexyl group, 4-ethylcyclohexyl group, 4-propylcyclohexyl group, 4-butylcyclohexyl group, 4-pentylcyclohexyl group, 4-hexylcyclohexyl group, 4-heptylcyclohexyl group, 4-octylcyclohexyl group, 4-nonylcyclohexyl group, and 4-decylcyclohexyl group, and 4-fluoroalkyl-cycloalkyl groups thereof substituted with fluorine atoms; 4-alkyl-cycloalkenyl groups, such as 4-propylcyclohexenyl group, 4-pentylcyclohexenyl group, and 4-fluoro alkyl-cycloalkenyl groups thereof substituted with fluorine atoms; cyano group; SF5; and NCS.

Concrete examples of the compound represented by formula (2) are shown below.

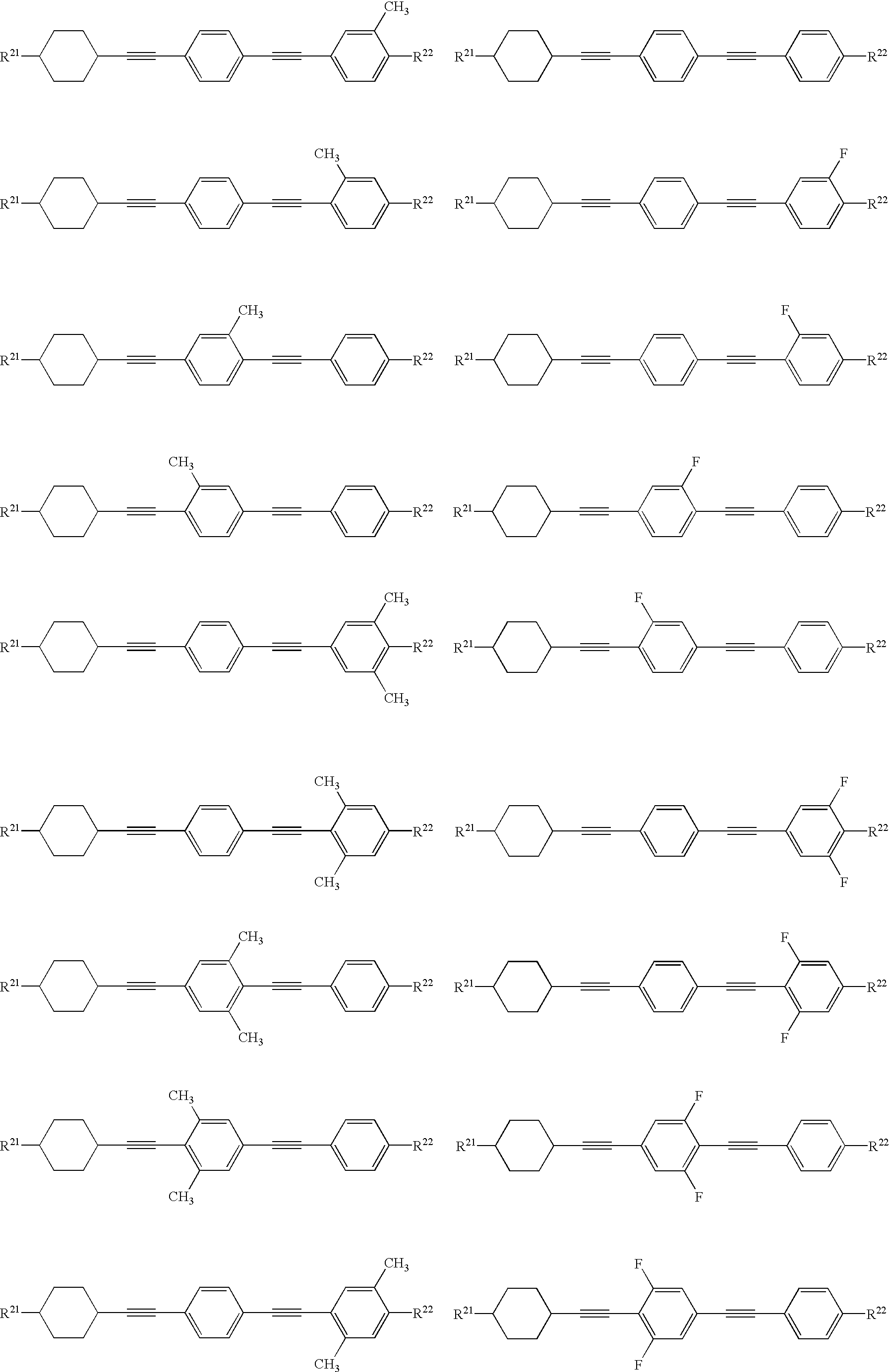

In the formula, concrete examples of R21 and R22 include: hydrogen atom; fluorine atom; alkyl groups such as methyl group, ethyl group, propyl group, butyl group, pentyl group, hexyl group, heptyl group, octyl group, nonyl group, decyl group, undecyl group and dodecyl group, and fluoroalkyl groups thereof substituted with fluorine atoms (for example, trifluoromethyl); alkoxy groups, such as methoxy group, ethoxy group, propoxy group, butoxy group, pentyloxy group, hexyloxy group, octyloxy group, nonyloxy group, decyloxy group, undecyloxy group, dodecyloxy group, fluoroalkoxy groups thereof substituted with fluorine atoms (for example, methoxy group substituted with 1-3 fluorine atoms, and ethoxy group substituted with 1-5 fluorine atoms; alkoxyalkyl groups, such as methoxymethyl group, ethoxymethyl group, propoxymethyl group, butoxymethyl group, pentyloxymethyl group, hexyloxymethyl group, heptyloxymethyl group, octyloxymethyl group, nonyloxymethyl group, decyloxymethyl group, methoxyethyl group, ethoxyethyl group, propoxyethyl group, butoxyethyl group, pentyloxyethyl group, hexyloxyethyl group, heptyloxyethyl group, octyloxyethyl group, nonyloxyethyl group, decyloxyethyl group, methoxypropyl group, ethoxypropyl group, propoxypropyl group, butoxypropyl group, pentyloxypropyl group, hexyloxypropyl group, heptyloxypropyl group, octyloxypropyl group, nonyloxypropyl group, methoxybutyl group, ethoxybutyl group, propoxybutyl group, butoxybutyl group, pentyloxybutyl group, hexyloxybutyl group, heptyloxybutyl group, octyloxybutyl group, methoxypentyl group, ethoxypentyl group, propoxypentyl group, butoxypentyl group, pentyloxypentyl group, hexyloxypentyl group, heptyloxypentyl group, and fluoroalkoxyalkyl groups thereof substituted with fluorine atoms; branched alkyl groups, such as 2-methylpropyl group, 2-methylbutyl group, 3-methylbutyl group, and 3-methylpentyl group, and branched fluoroalkyl groups thereof substituted with fluorine atoms; branched alkyloxy groups, such as 2-methylpropyloxy group, 2-methylbutyloxy group, 3-methylbutyloxy group, and 3-methylpentyloxy group, and branched fluoroalkyloxy groups thereof substituted with fluorine atoms; 4-alkyl-cycloalkyl groups, such as 4-methylcyclohexyl group, 4-ethylcyclohexyl group, 4-propylcyclohexyl group, 4-butylcyclohexyl group, 4-pentylcyclohexyl group, 4-hexylcyclohexyl group, 4-heptylcyclohexyl group, 4-octylcyclohexyl group, 4-nonylcyclohexyl group, and 4-decylcyclohexyl group, and 4-fluoroalkyl-cycloalkyl groups thereof substituted with fluorine atoms; 4-alkyl-cycloalkenyl groups, such as 4-propylcyclohexenyl group, 4-pentylcyclohexenyl group, and 4-fluoroalkyl-cycloalkenyl groups thereof substituted with fluorine atoms; cyano group; SF5; and NCS.

Concrete examples of the compound represented by formula (3) are shown below.

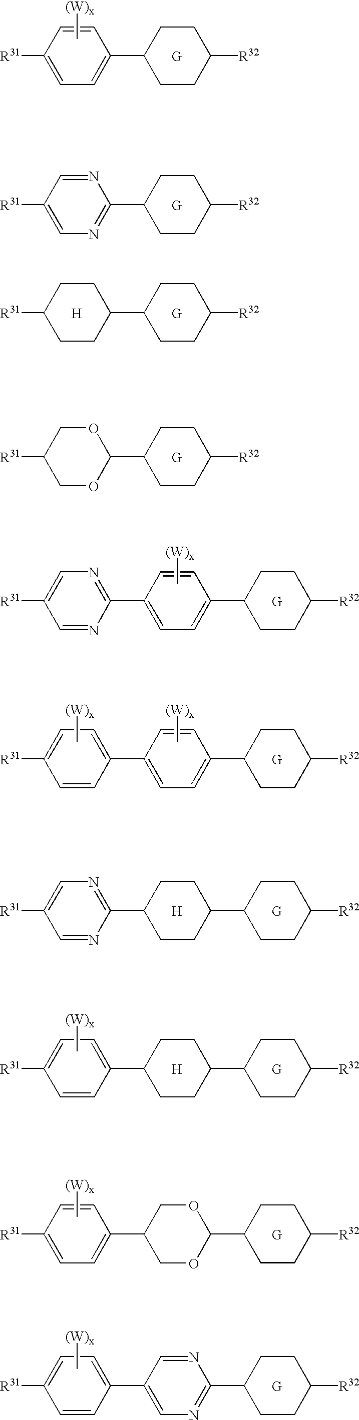

In the formula, concrete examples of R31 include: hydrogen atom; and following groups which may be substituted with fluorine, such as, methyl, ethyl, propyl, butyl, pentyl, hexyl, heptyl, octyl, nonyl, decyl, undecyl, dodecyl, ethenyl, propenyl, butenyl, pentenyl, hexenyl, heptenyl, octenyl, nonenyl, decenyl, undecenyl, dodecenyl, methoxy, ethoxy, propoxy, butoxy, pentyloxy, hexyloxy, heptyloxy, octyloxy, nonyloxy, decyloxy, undecyloxy, dodecyloxy, vinyloxy, propenyloxy, butenyloxy, pentenyloxy, hexynyloxy, heptenyloxy, octenyloxy, nonenyloxy, decenyloxy, propynyloxy, butynyloxy, pentynyloxy, hexynyloxy, heptynyloxy, octynyloxy, nonynyloxy, decynyloxy, undecynylloxy, dodecynyloxy, methoxymethyl, ethoxymethyl, propoxymethyl, butoxymethyl, pentyloxymethyl, hexyloxymethyl, heptyloxy methyl, octyloxy methyl, nonyloxymethyl, decyloxymethyl, methoxyethyl, ethoxyethyl, propoxyethyl, butoxyethyl, pentyloxyethyl, hexyloxyethyl, heptyloxyethyl, octyloxyethyl, nonyloxyethyl, decyloxyethyl, methoxypropyl, ethoxypropyl, propoxypropyl, butoxypropyl, pentyloxypropyl, hexyloxypropyl, heptyloxypropyl, octyloxypropyl, nonyloxypropyl, decyloxypropyl, methoxybutyl, ethoxybutyl, propoxybutyl, butoxybutyl, pentyloxybutyl, hexyloxybutyl, heptyloxybutyl, octyloxybutyl, nonyloxybutyl, decyloxybutyl, methoxypentyl, ethoxypentyl, propoxypentyl, butoxypentyl, pentyloxypentyl, hexyloxypentyl, heptyloxypentyl, octyloxypentyl, nonyloxypentyl, and decyloxypentyl.

Concrete examples of R32 include: hydrogen atom, fluorine atom, fluoromethyl group, difluoromethyl group, trifluoromethyl group, fluoromethoxy group, difluoromethoxy group, trifluoromethoxy group, cyano group; and following groups which may be substituted with fluorine, such as, methyl, ethyl, propyl, butyl, pentyl, hexyl, heptyl, octyl, nonyl, decyl, undecyl, dodecyl, ethenyl, propenyl, butenyl, pentenyl, hexenyl, heptenyl, octenyl, nonenyl, decenyl, undecenyl, dodecenyl, methoxy, ethoxy, propoxy, butoxy, pentyloxy, hexyloxy, heptyloxy, octyloxy, nonyloxy, decyloxy, undecyloxy, dodecyloxy, vinyloxy, propenyloxy, butenyloxy, pentenyloxy, hexynyloxy, heptenyloxy, octenyloxy, nonenyloxy, decenyloxy, propynyloxy, butynyloxy, pentynyloxy, hexynyloxy, heptynyloxy, octynyloxy, nonynyloxy, decynyloxy, undecynylloxy, dodecynyloxy, methoxymethyl, ethoxymethyl, propoxymethyl, butoxymethyl, pentyloxymethyl, hexyloxymethyl, heptyloxymethyl, octyloxymethyl, nonyloxymethyl, decyloxymethyl, methoxyethyl, ethoxyethyl, propoxyethyl, butoxyethyl, pentyloxyethyl, hexyloxyethyl, heptyloxyethyl, octyloxyethyl, nonyloxyethyl, decyloxyethyl, methoxypropyl, ethoxypropyl, propoxypropyl, butoxypropyl, pentyloxypropyl, hexyloxypropyl, heptyloxypropyl, octyloxypropyl, nonyloxypropyl, decyloxypropyl, methoxybutyl, ethoxybutyl, propoxybutyl, butoxybutyl, pentyloxybutyl, hexyloxybutyl, heptyloxybutyl, octyloxybutyl, nonyloxybutyl, decyloxybutyl, methoxypentyl, ethoxypentyl, propoxypentyl, butoxypentyl, pentyloxypentyl, hexyloxypentyl, heptyloxypentyl, octyloxypentyl, nonyloxypentyl, and decyloxypentyl. W represents a hydrogen atom or a fluorine atom. X is an integer of 0 to 3.

In the formula,

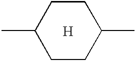

represents 1,4-cyclohexylene.

In the formula,

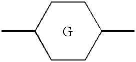

represents following groups which may be substituted with fluorine, such as 1,4-phenylene, 1,4-cyclohexylene, 1,4-cyclohexelene, 4,1-cyclohexelene, 2,5-cyclohexelene, 5,2-cyclohexelene, 3,6-cyclohexelene, 6,3-cyclohexelene, 2,5-pyrimidinediyl, 5,2-pyrimidinediyl, 2,5-pyridinediyl, 5,2-pyridinediyl, 2,5-dioxanediyl or 5,2-dioxanediyl.

Suitably, the above ring G is 1,4-cyclohexylene, 1,4-cyclohexelene, 4,1-cyclohexelene, 2,5-cyclohexelene, 5,2-cyclohexelene, 3,6-cyclohexelene and 6,3-cyclohexelene.

The above liquid crystal can be used with mixing a polymerizable substance.

As the polymerizable substance, either of thermoplastic, thermosetting or photopolymerizable type substance can be used. As the examples of the photopolymerizable type substances, suitably used are the photopolymerizable isotropic organic substances exemplified before.

For accelerating the polymerization, a polymerization initiator may also be added to the above mixture of a liquid crystal and a polymerizable substance. As the examples of such an initiator, suitably used are the photopolymerization initiators exemplified before.

Next, a method for producing the anisotropic scattering film of the present invention will be explained.

The anisotropic scattering film of the present invention is produced, for example, by filling a substance having a different refractive index from the micro-porous film in the micro-pores of the film. The filling method is not particularly restricted, and the filled substance is desirably in liquid or liquid crystalline state at room temperature (about 20° C.). When it is not in liquid or liquid crystalline state at room temperature, it may be heated, if necessary, to be changed into liquid or liquid crystalline state, or it may be dissolved in a solvent to give a solution which is filled in micro pores before removal of the solvent.

When the filled substance is a polymerizable substance, it may be sandwiched between films or glass plates and polymerized, though the means thereof is not restricted.

The anisotropic scattering film thus obtained has a dependency on polarized light of transmittance-scattering, i.e., scattering anisotropy, to a polarizing component of a polarized light.

Moreover, when the substance filled in the micro-pores is an anisotropic substance, it is preferable that the anisotropic substance is oriented to substantially in one direction, further preferably is oriented to substantially in the direction of the major axis of ellipse in the region of this ellipse on the surface of a film.

A liquid crystal display using the above-mentioned anisotropic scattering film will be explained.

The display comprising a liquid crystal panel having a polarizing plate at least on the front surface side, an anisotropic scattering film above mentioned, a light guide, and a reflection plate or diffuse reflection plate piled in this order. The transmission axis of the above-mentioned anisotropic scattering film and the transmission axis of the above-mentioned liquid crystal panel being approximately parallel. It is preferable that a retardation plate, particularly, a ¼ wavelength plate is placed between the light guide and the above-mentioned reflection plate, from the standpoint of effective utilization of light. The light guide is included in a back light device, and examples of the back light device include a side type back light device and a direct-under type back light device which effect illumination through a light guide from a light source.

Then, the polarization conversion in liquid crystal panel is explained.

As shown in FIG. 5, light emitted from a back light is composed of orthogonally crossing polarized lights, e.g. polarized light having a plane of vibration parallel to the paper surface and light having a plane of vibration vertical to the paper surface.

The anisotropic scattering film of the present invention comprises a micro-porous film and a substance filled in micro pores of said micro-porous film, the micro pores and penetrating pores observed on the surface of the film are substantially in the form of ellipse, and the refractive index of the substance in micro pores differs from that of the micro-porous film.

In the anisotropic scattering film of the present invention, for example, polarized light having a plane of vibration vertical to the paper surface transmits, and polarized light having a plane of vibration parallel to the paper surface is back-scattered. Here, the direction parallel to the plane of vibration of transmitted polarized light is a transmission axis, and the direction vertical to the plane of vibration of scattered polarized light is a scattering axis.

The polarized light back-scattered by an anisotropic scattering film is reflected or scattering-reflected by a reflection plate or a diffuse reflection plate on the back side of the back light, and transmit the anisotropic scattering film again. Thus, the light which had been absorbed by a polarizing plate can be back-scattered and recycled and a liquid crystal display having improved luminance can be obtained.

### EXAMPLES

Next, the present invention is explained by the examples, but the scope of the present invention is not restricted by them.

Physical properties were measured as follows.

Gas permeability: Measured with using Gurley Type Densometer (No.323 type, produced by Yasuda Seiki Seisaku-sho Co.) according to JIS P8117.

Progressive light transmittance: When progressive polarized light through a polarizing plate is input normally to an anisotropic scattering film, and the transmittance was measured by rotating a sample within a film plane. The maximum value of the transmitted light is the progressive light transmittance in a transmission state, and the minimum value is the progressive light transmittance in a scattering state. As a light source, a halogen lamp (SPH-100N, produced by Chuo Precision Industrial Co., Ltd.) was used, and the transmitted light was detected by Optical power meter (ML9001A, produced by Anritsu Corporation, wavelength of 400 nm to 800 nm).

Total light transmittance: A light source (GOLD LIGHT HL100E produced by Hoya-SCOTT Co.) through a polarizing plate is used as a polarized light source. Total light transmittance is measured by using an integrating sphere(RT-060-SF type produced by Labsphere Co.).

The total light transmittances of a transmission state and a scattering state when polarized light was input normally to an anisotropic scattering film, parallel to the transmission axis and the scattering axis of a sample respectively, were obtained by measuring the quantity of light with a luminancemeter(BM-8, produced by TOPCON Co.) according to JIS K7105.

Transmittance when polarized light having a vibration direction parallel to the transmission axis of an anisotropic scattering film was input, is defined as a transmittance in a transmission state, and transmittance when polarized light having a vibration direction vertical to the transmission axis of an anisotropic scattering film was input, is defined as a transmittance in a scattering state.

### Comparative Example 1

Toluene (refractive index 1.50) was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, the directions along the major axis direction are substantially oriented to one direction, and gas permeability is 700 sec/100 cc·cm². This was sandwiched between glass plates (# 7059) manufactured by Corning.

Provided that the transmittance of the glass plate is taken for 100%, the progressive light transmittance of the above-mentioned film were 88.9% in transmission state and 87.2% in scattering state. The total light transmittance of the above-mentioned film obtained in the same manner, were 89.9% in a transmission state, and 89.5% in scattering state.

Thus when a substance having the same refractive index as that of a micro-porous film was filled in the micro pores of the micro-porous film, dependency on polarized light (scattering anisotropy) was scarcely observed.

### Example 1

1-bromonaphthalene (refractive index 1.66) was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, and directions along the major axis direction are substantially oriented to one direction, and gas permeability is 700 sec/100 cc·cm². This was sandwiched between glass plates (# 7059) manufactured by Corning.

Provided that the transmittance of the glass plate is taken for 100%, the progressive light transmittance of the above-mentioned film were 62.3% in transmission state and 42.5% in scattering state. The total light transmittance of the above-mentioned film obtained in the same manner, were 79.6% in a transmission state, and 65.4% in scattering state.

### Example 2

1-bromonaphthalene (refractive index 1.66) was filled in a polypropylene-polyethylene-polypropylene (3-layer structure) micro porous film having a refractive index of 1.50 and a thickness of 25 μm in which a micro pores observed by an electron microscope on the surface of the film was substantially in the form of ellipse, the average aspect ratio of the ellipse form was 10, the average minor axis size of micro pores was 0.2 μm, the average major axis size was 2.0 μm, and directions along the major axis direction are substantially oriented to one direction, and gas permeability is 521 sec/100 cc·cm². This was sandwiched between glass plates (# 7059) manufactured by Corning.

Provided that the transmittance of the glass plate is taken for 100%, the progressive light transmittance of the above-mentioned film were 70.0% in transmission state and 47.5% in scattering state. The total light transmittance of the above-mentioned film obtained in the same manner, were 85.2% in a transmission state, and 73.4% in scattering state.

### Example 3

A monomer prepared by adding 1 wt % of Irgacure 651 and 1 wt % of Irgacure 184 (manufactured by Chiba Specialty Chemicals) to MPV (manufactured by Sumitomo Seika Chemicals Co., Ltd., refractive index 1.70) was filled, on a polycarbonate film, in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, the directions along the major axis direction are substantially oriented to one direction, and gas permeability is 700 sec/100 cc·cm². On this was laminated a polycarbonate film, and was pressed with a rubber roller to defoam.

The above-mentioned film was irradiated at 25° C. with ultraviolet ray of 29 mW/cm² for 120 seconds using a ultraviolet ray irradiation apparatus having a mercury lamp as a light source, to cause polymerization.

Polycarbonate of the resulted film was peeled, and a film was obtained in which MPV filled in the polypropylene micro porous film had been polymerized.

Provided that the transmittance in the case of no film (blank) is taken for 100%, the progressive light transmittance of the above-mentioned film were 24.3% in transmission state and 14.8% in scattering state. The total light transmittance of the above-mentioned film obtained in the same manner, were 73.8% in a transmission state, and 63.1% in scattering state.

### Example 4

Acetone (refractive index 1.36) was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, and directions along the major axis direction are substantially oriented to one direction, and gas permeability is 700 sec/100 cc·cm². This was sandwiched between glass plates (# 7059) manufactured by Corning.

Provided that the transmittance of the glass plate is taken for 100%, the progressive light transmittance of the above-mentioned film were 48.5% in transmission state and 44.5% in scattering state. The total light transmittance of the above-mentioned film obtained in the same manner, were 76.3% in a transmission state, and 70.3% in scattering state.

### Example 5

1-bromonaphthalene (refractive index 1.66) was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 28.6, the average minor axis size of micro pores was 0.21 μm, the average major axis size was 6.0 μm, and directions along the major axis direction are substantially oriented to one direction, and gas permeability is 173 sec/100 cc·cm². This was sandwiched between glass plates (# 7059) manufactured by Corning.

Provided that the transmittance of the glass plate is taken for 100%, the progressive light transmittance of the above-mentioned film were 3.1% in transmission state and 1.6% in scattering state. The total light transmittance of the above-mentioned film obtained in the same manner, were 79.6% in a transmission state, and 68.7% in scattering state.

### Example 6

1-bromonaphthalene (refractive index 1.66) was filled in a polypropylene-polyethylene-polypropylene (3-layer structure) micro porous film having a refractive index of 1.50 and a thickness of 25 μm in which a micro pores observed by an electron microscope on the surface of the film was substantially in the form of ellipse, the average aspect ratio of the ellipse form was 22.2, the average minor axis size of micro pores was 0.09 μm, the average major axis size was 2.0 μm, and directions along the major axis direction are substantially oriented to one direction, and gas permeability is 628 sec/100 cc·cm². This was sandwiched between glass plates (# 7059) manufactured by Corning.

Provided that the transmittance of the glass plate is taken for 100%, the progressive light transmittance of the above-mentioned film were 67.8% in transmission state and 42.1% in scattering state. The total light transmittance of the above-mentioned film obtained in the same manner, were 82.9% in a transmission state, and 68.3% in scattering state.

### Example 7

Acetone (refractive index 1.36) was filled in a separator film for lithium secondary battery (H6022, produced by Asahi Chemical Industry) having a refractive index of about 1.50 and a thickness of 27 μm in which a micro pores observed by an electron microscope on the surface of the film was substantially in the form of ellipse, the average aspect ratio of the ellipse form was 2, the average minor axis size of micro pores was 0.2 μm, the average major axis size was 0.5 μm, and directions along the major axis direction are substantially oriented to one direction, and gas permeability is 82 sec/100 cc·cm². This was sandwiched between glass plates (# 7059) manufactured by Corning.

Provided that the transmittance of the glass plate is taken for 100%, the progressive light transmittance of the above-mentioned film were 0.6% in transmission state and 0.2% in scattering state. The total light transmittance of the above-mentioned film obtained in the same manner, were 59.6% in a transmission state, and 44.1% in scattering state.

### Example 8

1-bromonaphthalene (refractive index 1.66) was filled in the porous film of Example 8. This was sandwiched between glass plates (# 7059) manufactured by Corning.

Provided that the transmittance of the glass plate is taken for 100%, the progressive light transmittance of the above-mentioned film were 12.4% in transmission state and 3.9% in scattering state. The total light transmittance of the above-mentioned film obtained in the same manner, were 70.4% in a transmission state, and 67.1% in scattering state.

### Example 9

The micro porous film of Example 8 was uniaxially drawn at 120° C. in a drawing ratio of 2 to produce a film in which micro pores observed by an electron microscope on the surface of the film were substantially in the form of ellipse, the average aspect ratio of the ellipse form was 4, the average minor axis size of micro pores was 0.2 μm, the average major axis size was 1.0 μm, and directions along the major axis direction are substantially oriented to one direction, and gas permeability is 694 sec/100 cc·cm².

Provided that the transmittance in the case of no film (blank) is taken for 100%, the progressive light transmittance of the above-mentioned film were 0.04% in transmission state and 0.02% in scattering state. The total light transmittance of the above-mentioned film obtained in the same manner, were 27.0% in a transmission state, and 18.2% in scattering state.

### Example 10

Acetone (refractive index 1.36) was filled in the micro porous film of Example 10. This was sandwiched between glass plates (# 7059) manufactured by Corning.

Provided that the transmittance of the glass plate is taken for 100%, the progressive light transmittance of the above-mentioned film were 17.6% in transmission state and 4.4% in scattering state. The total light transmittance of the above-mentioned film obtained in the same manner, were 71.2% in a transmission state, and 49.5% in scattering state.

### Example 11

1-bromonaphthalene (refractive index 1.66) was filled in a polyethylene-polyethylene-polyethylene micro porous film having a refractive index of 1.50 and a thickness of 25 μm in which micro pores observed by an electron microscope on the surface of the film were substantially in the form of ellipse, the average aspect ratio of the ellipse form was 5.6, the average minor axis size of micro pores was 0.18 μm, the average major axis size was 1.0 μm, and directions along the major axis direction are substantially oriented to one direction, and gas permeability is 700 sec/100 cc·cm². This was sandwiched between glass plates (# 7059) manufactured by Corning.

Provided that the transmittance of the glass plate is taken for 100%, the progressive light transmittance of the above-mentioned film were 70.9% in transmission state and 42.5% in scattering state. The total light transmittance of the above-mentioned film obtained in the same manner, were 84.1% in a transmission state, and 66.5% in scattering state.

### Example 12

A separator film for lithium secondary battery (SETELA, produced by Tohnen Chemical Co.; refractive index of about 1.50, thickness of 26 μm, gas permeability is 725 sec/100 cc·cm²) was uniaxially drawn at 100° C. in a drawing ratio of 1.9 to produce a micro porous film. Micro pores on the surface of the film observed by an electron microscope were substantially in the form of ellipse, and the average aspect ratio of the ellipse form was 2, the average minor axis size of micro pores was 0.1 μm which is shorter than the wavelength of light, the average major axis size was 0.4 μm which is longer than the wavelength of light, and directions along the major axis direction were substantially oriented to one direction. Acetone (refractive index 1.36) was filled in the micro porous film, and this was sandwiched between glass plates (# 7059) manufactured by Corning.

Provided that the transmittance of the glass plate is taken for 100%, the progressive light transmittance of the above-mentioned film were 39.8% in transmission state and 25.3% in scattering state. The total light transmittance of the above-mentioned film obtained in the same manner, were 83.0% in a transmission state, and 76.5% in scattering state.

### Example 13

An anisotropic substance (liquid crystal mixuture E9, produced by Merck & Co., refractive index no=1.52, ne=1.78), was filled in a polypropylene micro porous film having a refractive index of 1.50 and a thickness of 30 μm in which a micro pores observed by an electron microscope on the surface of the film was substantially in the form of ellipse, the average aspect ratio of the ellipse form was 10, the average minor axis size of micro pores was 0.3 μm, the average major axis size was 3.0 μm, and directions along the major axis direction are substantially oriented to one direction, and gas permeability is 3990 sec/100 cc·cm².

Provided that the transmittance in the case of no anisotropic scattering film (blank) is taken for 100%, the progressive light transmittance of the above-mentioned film were 30.0% in transmission state and 2.5% in scattering state. The total light transmittance of the above-mentioned film obtained in the same manner, were 85.3% in a transmission state, and 47.2% in scattering state.

### Example 14

80% by weight of an anisotropic substance (liquid crystal mixture E7 produced by Merck & Co., refractive index no=1.52, ne=1.75), 19.6% by weight of a monomer (KAYARAD HX-620, produced by Nippon Kayaku Co., Ltd.) and 0.4% by weight of Irgacure 651 (produced by Chiba Specialty Chemicals)were mixed to produce a anisotropic polymerizable substance, which was filled in a polypropylene-polyethylene-polypropylene (3-layer structure) micro porous film having a refractive index of 1.50 and a thickness of 25 μm in which a micro pores observed by an electron microscope on the surface of the film was substantially in the form of ellipse, the average aspect ratio of the ellipse form was 22.2, the average minor axis size of micro pores was 0.09 μm, the average major axis size was 2.0 μm, and directions along the major axis direction are substantially oriented to one direction.

The above-mentioned film was irradiated by ultraviolet of 29 mW/cm² at 25° C. for 120 seconds with using a UV irradiation machine having a mercury lamp as a light source, and the anisotropic polymerizable substance filled in the micro pores was polymerized.

Provided that the transmittance in the case of no anisotropic scattering film (blank) is taken for 100%, the progressive light transmittance of the above-mentioned film were 86.4% in transmission state and 43.6% in scattering state. The total light transmittance of the above-mentioned film obtained in the same manner, were 91.1% in a transmission state, and 76.0% in scattering state.

### Example 15

An anisotropic substance (liquid crystal mixture E9, produced by Merck & Co., refractive index no=1.52, ne=1.78), was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, and directions along the major axis direction are substantially oriented to one direction, and gas permeability is 700 sec/100 cc·cm².

Provided that the transmittance in the case of no anisotropic scattering film (blank) is taken for 100%, the progressive light transmittance of the above-mentioned film were 77.9% in transmission state and 37.0% in scattering state. The total light transmittance of the above-mentioned film obtained in the same manner, were 88.0% in a transmission state, and 64.7% in scattering state.

### Example 16

An anisotropic substance (liquid crystal mixture E9, produced by Merck & Co., refractive index no=1.52, ne=1.78), was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 28.6, the average minor axis size of micro pores was 0.21 μm, the average major axis size was 6.0 μm, and directions along the major axis direction are substantially oriented to one direction, and gas permeability is 173 sec/100 cc·cm².

Provided that the transmittance in the case of no anisotropic scattering film (blank) is taken for 100%, the progressive light transmittance of the above-mentioned film were 49.8% in transmission state and 5.8% in scattering state. The total light transmittance of the above-mentioned film obtained in the same manner, were 89.1% in a transmission state, and 61.6% in scattering state.

### Example 17

An anisotropic substance (4′pentyl-4-biphenylcarbonitrile, produced by Aldrich [symbol] , refractive index no=1.51, ne=1.68), was filled in a polypropylene-polyethyylene-polypropylene (3 layer structure) micro porous film having a refractive index of 1.50 and a thickness of 25 μm in which a micro pores observed by an electron microscope on the surface of the film was substantially in the form of ellipse, the average aspect ratio of the ellipse form was 22.2, the average minor axis size of micro pores was 0.09 μm, the average major axis size was 2.0 μm, and directions along the major axis direction are substantially oriented to one direction, and gas permeability is 628 sec/100 cc·cm².

Provided that the transmittance in the case of no anisotropic scattering film (blank) is taken for 100%, the progressive light transmittance of the above-mentioned film were 92.8% in transmission state and 39.8% in scattering state. The total light transmittance of the above-mentioned film obtained in the same manner, were 88.1% in a transmission state, and 82.7% in scattering state.

### Example 18

An anisotropic substance (liquid crystal mixture E9, produced by Merck & Co., refractive index no=1.52, ne=1.78), was filled in a polypropylene micro porous film having a refractive index of 1.50 and a thickness of 42 μm in which a micro pores observed by an electron microscope on the surface of the film was substantially in the form of ellipse, the average aspect ratio of the ellipse form was 15, the average minor axis size of micro pores was 0.2 μm, the average major axis size was 3.0 μm, and directions along the major axis direction are substantially oriented to one direction, and gas permeability is 1232 sec/100 cc·cm².

Provided that the transmittance in the case of no anisotropic scattering film (blank) is taken for 100%, the progressive light transmittance of the above-mentioned film were 58.1% in transmission state and 4.8% in scattering state. The total light transmittance of the above-mentioned film obtained in the same manner, were 84.0% in a transmission state, and 48.7% in scattering state.

### Example 19

An anisotropic substance (liquid crystal mixture E9, produced by Merck & Co., refractive index no=1.52, ne=1.78), was filled in a polypropylene-polyethyylene-polypropylene (3 layer structure) micro porous film having a refractive index of 1.50 and a thickness of 25 μm in which a micro pores observed by an electron microscope on the surface of the film was substantially in the form of ellipse, the average aspect ratio of the ellipse form was 22.2, the average minor axis size of micro pores was 0.09 μm, the average major axis size was 2.0 μm, and directions along the major axis direction are substantially oriented to one direction, and gas permeability is 628 sec/100 cc·cm².

Provided that the transmittance in the case of no anisotropic scattering film (blank) is taken for 100%, the progressive light transmittance of the above-mentioned film were 84.1% in transmission state and 26.7% in scattering state. The total light transmittance of the above-mentioned film obtained in the same manner, were 90.1% in a transmission state, and 67.3% in scattering state.

### Example 20

An anisotropic substance (liquid crystal mixture E9, produced by Merck & Co., refractive index no=1.52, ne=1.78), was filled in a polypropylene-polyethyylene-polypropylene (3 layer structure) micro porous film having a refractive index of 1.50 and a thickness of 25 μm in which a micro pores observed by an electron microscope on the surface of the film was substantially in the form of ellipse, the average aspect ratio of the ellipse form was 5.6, the average minor axis size of micro pores was 0.18 μm, the average major axis size was 1.0 μm, and directions along the major axis direction are substantially oriented to one direction, and gas permeability is 551 sec/100 cc·cm².

Provided that the transmittance in the case of no anisotropic scattering film (blank) is taken for 100%, the progressive light transmittance of the above-mentioned film were 77.8% in transmission state and 19.7% in scattering state. The total light transmittance of the above-mentioned film obtained in the same manner, were 89.8% in a transmission state, and 68.2% in scattering state.

### Example 21

An anisotropic substance (liquid crystal mixture A consisting Compounds 3-1, 3-2, 3-3 and 3-4 represented by the general formula (2) in a ratio shown in Table 1, refractive index no=1.51, ne=1.91), was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 16.7, the average minor axis size of micro pores was 0.12 μm, the average major axis size was 2.0 μm, and directions along the major axis direction are substantially oriented to one direction, and gas permeability is 700sec/100 cc·cm².

TABLE 1

| | | % by |
|---|---|---|
| | | weight |
| Compound 3-1 | 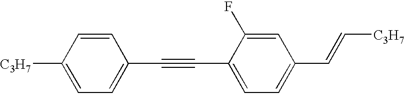 | 46.2 |
| Compound 3-2 | 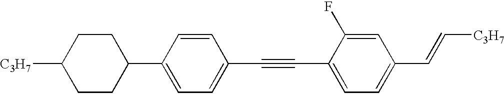 | 31.8 |
| Compound 3-3 | 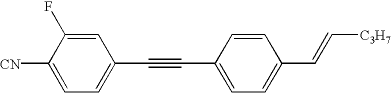 | 13.7 |
| Compound 3-4 | 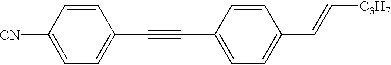 | 8.3 |

Provided that the transmittance in the case of no anisotropic scattering film (blank) is taken for 100%, the progressive light transmittance of the above-mentioned film were 68.2% in transmission state and 9.7% in scattering state. The total light transmittance of the above-mentioned film obtained in the same manner, were 88.2% in a transmission state, and 58.9% in scattering state.

### Example 22

An anisotropic substance (liquid crystal mixture A consisting Compounds 3-1, 3-2, 3-3 and 3-4 represented by the general formula (2) in a ratio shown in Table 1, refractive index no=1.51, ne=1.91), was filled in a polypropylene micro porous film having a refractive index of 1.50 and a thickness of 25 μm in which a micro pores observed by an electron microscope on the surface of the film was substantially in the form of ellipse, the average aspect ratio of the ellipse form was 22.2, the average minor axis size of micro pores was 0.09 μm, the average major axis size was 2.0 μm, and directions along the major axis direction are substantially oriented to one direction, and gas permeability is 628 sec/100 cc·cm².

Provided that the transmittance in the case of no anisotropic scattering film (blank) is taken for 100%, the progressive light transmittance of the above-mentioned film were 73.4% in transmission state and 7.3% in scattering state. The total light transmittance of the above-mentioned film obtained in the same manner, were 90.6% in a transmission state, and 61.6% in scattering state.

### Example 23

An anisotropic substance (liquid crystal mixture E9, produced by Merck & Co., refractive index no=1.52, ne=1.78), was filled in a separator film for lithium secondary battery (H6022, produced by Asahi Chemical Industry) having a refractive index of about 1.50 and a thickness of 27 μm in which a micro pores observed by an electron microscope on the surface of the film was substantially in the form of ellipse, the average aspect ratio of the ellipse form was 2, the average minor axis size of micro pores was 0.2 μm, the average major axis size was 0.5 μm, and directions along the major axis direction are substantially oriented to one direction, and gas permeability is 82 sec/100 cc·cm².

Provided that the transmittance in the case of no anisotropic scattering film (blank) is taken for 100%, the progressive light transmittance of the above-mentioned film were 0.6% in transmission state and 0.5% in scattering state. The total light transmittance of the above-mentioned film obtained in the same manner, were 56.0% in a transmission state, and 50.5% in scattering state.

### Example 24

The micro porous film of Example 11 was uniaxially drawn at 120° C. in a drawing ratio of 2 to produce a film in which micro pores observed by an electron microscope on the surface of the film were substantially in the form of ellipse, the average aspect ratio of the ellipse form was 4, the average minor axis size of micro pores was 0.2 μm, the average major axis size was 1.0 μm, and directions along the major axis direction are substantially oriented to one direction, and gas permeability is 694 sec/100 cc·cm². In the above micro porous film, an anisotropic substance (liquid crystal mixture E9, produced by Merck & Co., refractive index no=1.52, ne=1.78), was filled.

Provided that the transmittance in the case of no anisotropic scattering film (blank) is taken for 100%, the progressive light transmittance of the above-mentioned film were 61.6% in transmission state and 6.4% in scattering state. The total light transmittance of the above-mentioned film obtained in the same manner, were 91.1% in a transmission state, and 53.6% in scattering state.

### Example 25

A separator film for lithium secondary battery (SETELA, produced by Tohnen Chemical Co.; refractive index of about 1.50, thickness of 26 μm, gas permeability is 725 sec/100 cc·cm²) was uniaxially drawn at 100° C. in a drawing ratio of 1.9 to produce a micro porous film. Micro pores on the surface of the film observed by an electron microscope were substantially in the form of ellipse, and the average aspect ratio of the ellipse form was 2, the average minor axis size of micro pores was 0.1 μm which is shorter than the wavelength of light, the average major axis size was 0.4 μm which is longer than the wavelength of light, and directions along the major axis direction were substantially oriented to one direction. In this film, an anisotropic substance (liquid crystal mixture E9, produced by Merck & Co., refractive index no=1.52, ne=1.78) was filled.

Provided that the transmittance in the case of no anisotropic scattering film (blank) is taken for 100%, the progressive light transmittance of the above-mentioned film were 59.5% in transmission state and 24.5% in scattering state. The total light transmittance of the above-mentioned film obtained in the same manner, were 91.0% in a transmission state, and 75.0% in scattering state.

As shown in the above Examples, films having higher dependency on polarized light (scattering anisotropy) as compared with Comparative Example 1 were obtained.

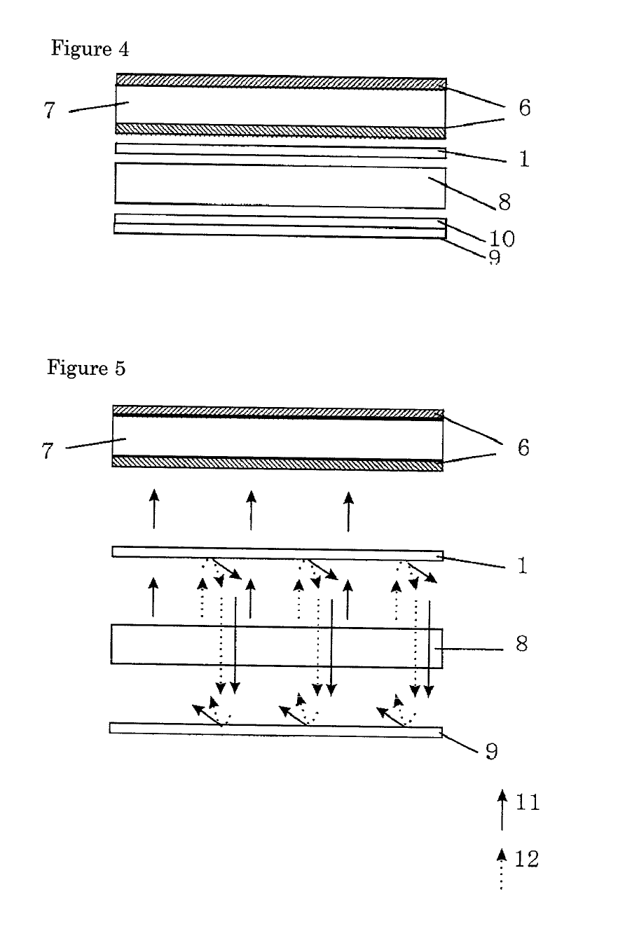

When the above-mentioned films are used for the constitution shown in FIG. 3 or 4, liquid crystal displays having improved luminance are obtained.

According to the present invention, an anisotropic scattering film which is produced by a easy method and has high scattering anisotropy can be obtained, and by using this anisotropic scattering film, a liquid crystal display having improved luminance can be provided.

What is claimed is:

1. An anisotropic scattering film comprising a micro-porous film and a substance in micro pores of said micro-porous film, wherein the micro pores observed on the surface of the film are substantially in the form of ellipse, the ratio of the major axis to the minor axis (major axis/minor axis) of said ellipse is over 1, the minor axis size of the micro pores is smaller than the wavelength of light, the directions of micro pores along the major axis are oriented to substantially one direction, the refractive index of the substance in micro pores of the micro-porous film differs from the refractive index of the micro-porous film, and the anisotropic scattering film has scattering anisotropy to a polarizing component of a polarized light.

2. The anisotropic scattering film according to claim 1, wherein the micro pores of the micro-porous film are filled with a substance having a refractive index different from the refractive index of the micro-porous film.

3. The anisotropic scattering film according to claim 1 or 2, wherein the micro-porous film is composed of a polymer.

4. The anisotropic scattering film according to any of claims 1 to 3, wherein the gas permeability of the micro-porous film is 5 to 5,000 sec/100 cc·cm².

5. The anisotropic scattering film according to any of claims 1 to 4, wherein the ratio of the major axis to the minor axis (major axis/minor axis) is 3 to 30.

6. The anisotropic scattering film according to any of claims 1 to 5, obtainable by polymerizing a polymerizable substance filled in the micro pores.

7. The anisotropic scattering film according to any of claims 1 to 6, wherein the substance in the micro pores is an anisotropic substance.

8. The anisotropic scattering film according to claim 7, wherein the anisotropic substance is oriented to substantially one direction.

9. The anisotropic scattering film according to claim 7 or 8, wherein
0.01<|n−ne|<0.6
0≦|n−no|<0.05
in the above formula, n is the refractive index of the micro-porous film, ne and no (ne>no) are the refractive index of the anisotropic substance.

10. The anisotropic scattering film according to any of claims 7 to 9, wherein the anisotropic substance is a liquid crystal.

11. The anisotropic scattering film according to claim 10, wherein the liquid crystal includes at least one compound selected from the compounds represented by the formulas (1) to (3): 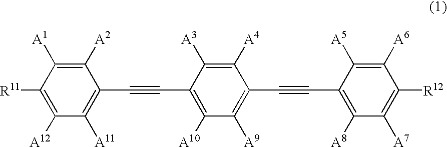
in the formula, A¹-A¹² represent, each independently, a hydrogen atom, a fluorine atom, an alkyl group or alkoxy group having 1-10 carbon atoms which may be substituted with fluorine; R¹¹ and R¹² represent, each independently, a hydrogen atom, a fluorine atom, a cyano group, SF₅, NCS, 4-R¹³-(cycloalkyl) group, 4-R¹³-(cycloalkenyl group) or R¹⁴—(O)q¹¹; R¹³ represents a hydrogen atom, a linear or branched alkyl group having 1-12 carbon atoms which may be substituted with fluorine; R¹⁴ represents a linear or branched alkyl group having 1-12 carbon atoms which may be substituted with fluorine; and q¹¹ represents 0 or 1, 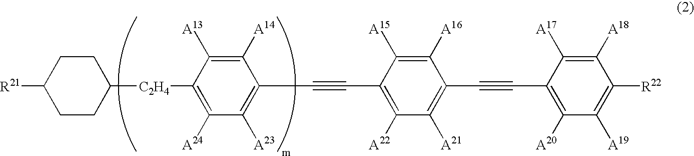
in the formula, A¹³-A²⁴ represent, each independently, a hydrogen atom, a fluorine atom, or an alkyl group having 1-10 carbon atoms; m is 0 or 1; R²¹ represents a hydrogen atom, a linear or branched alkyl group having 1-12 carbon atoms which may be substituted with fluorine; R²²represents R²¹, a fluorine atom, a cyano group, 4-R²³-(cycloalkyl) group, 4-R²³-(cycloalkenyl group) or R²⁴—(O)q²¹; R²³ represents a hydrogen atom, a linear or branched alkyl group having 1-12 carbon atoms which may be substituted with fluorine, and R²⁴ represents a linear or branched alkyl group having 1-12 carbon atoms which may be substituted with fluorine; and q²¹ represents 0 or 1, 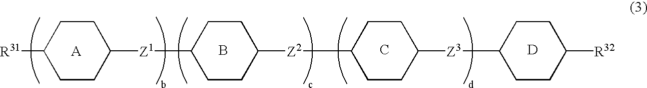
in the formula (3), ring A, ring B, ring C and ring D, each independently, represents, 1,4-phenylene, 1,4-cyclohexylene, 1,4-cyclohexelene, 4,1-cyclohexelene, 2,5-cyclohexelene, 5,2-cyclohexelene, 3,6-cyclohexelene, 6,3-cyclohexelene, 2,5-pyrimidinediyl, 5,2-pyrimidinediyl, 2,5-pyridinediyl, 5,2-pyridinediyl, 2,5-dioxanediyl or 5,2-dioxanediyl; hydrogen atoms on ring A, ring B, ring C, and ring D may be substituted with fluorine; R31 and R32 represent a hydrogen atom, a fluorine atom, fluoromethyl group, difluoromethyl group, trifluoromethyl group, fluoromethoxy group, difluoromethoxy group, trifluoro methoxy group, cyano group, an alkyl group having 1-12 carbon atoms, an alkenyl group having 3-12 carbon atoms, an alkynyl group having 3-12 carbon atoms, an alkoxy group having 1-12 carbon atoms, an alkenyloxy group having 3-12 carbon atoms, an alkynyloxy group having 3-12 carbon atoms, an alkoxyalkyl group having 2-16 carbon atoms, or an alkoxyalkenyl group having 3-16 carbon atoms; the methylene group in these alkyl group, alkenyl group and alkynyl group, may be substituted with oxygen atom, sulfur atom, and silicon atom, and can be either linear or branched; Z1, Z2, and Z3 represent, each independently, —COO—, —OCO—, —OCH₂—, —CH₂O—, an alkylene group having 1-5 carbon atoms, an alkenylene group having 2-5 carbon atoms, an alkynylene group having 2-5 carbon atoms, or a single bond; and b, c and d are 0 or 1 each independently, and satisfy b+c+d≧1.

12. A liquid crystal display comprising a liquid crystal panel having a polarizing plate at least on the front surface side, the anisotropic scattering film described in any of claims 1 to 11, a light guide, and a reflection plate or a diffuse reflection plate piled in this order, wherein the transmission axis of said liquid crystal panel and the transmission axis of said anisotropic scattering film are approximately parallel.

13. The liquid crystal display according to claim 12 wherein the liquid crystal panel has a polarizing plate on the front surface side and the back surface side.

14. The liquid crystal display according to claim 13 wherein the transmission axis of a polarizing plate on the back surface side of the liquid crystal panel and the transmission axis of the anisotropic scattering film are approximately parallel.

15. The liquid crystal display according to any of claims 12 to 14 wherein a retardation plate is located between the anisotropic scattering film and the reflection plate or diffuse reflection plate.
